(19) United States
(12) Patent Application Publication
(10) Pub. No.: US 2003/0001882 A1
(43) Pub. Date: Jan. 2, 2003

(54) Portable entertainment machines

(76) Inventors: Peter J. Macer, Bristol (GB); James Thomas Edward McDonnell, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 09/894,917

(22) Filed: Jun. 29, 2001

(51) Int. Cl. G06F 15/16; G09G 5/00

(52) U.S. Cl. 345/733; 709/217; 345/747

(57) ABSTRACT

A portable entertainment machine (1) is used for storing, displaying and swapping digital objects such as virtual swap cards or tokens, video clips, or game features relating to a game that can be played on the machine. The machine has a selected article window display (8) in which the user can display digital objects, or icons (8a, 8b, 8c, 8d) corresponding to digital objects, that have been selected by the machine user as being potentially available for swapping with another machine.

The machine is provided with a short-range wireless transceiver (7) and when the machine comes within range of another such machine, the possibility arises of a digital object swap transaction. Articles offered for swap by the second machine (1′), FIG. 2, are displayed in a reciprocal display portion (10) of the display 3 of the first machine, and the content of the selected article display (8) of the first machine is displayed to the user of the second machine in the reciprocal display portion (10) of the second machine (1′).

The user of the first machine can indicate a proposed swap in the linking indicator display portion (9). If both machine users agree on a proposed swap then the swap is executed.

Additional digital objects may be acquired by purchase from a static digital object vending machine, FIG. 6, by means of short-range wireless communication.

### FIELD OF THE INVENTION

This invention relates to portable entertainment machines, and particularly to portable entertainment machines provided with a short-range wireless communication facility which enables the machines to communicate one with another when the machines are within range.

The term ‘entertainment machine’ is used herein to include machines on which one or more games may be played, but also to include machines which are adapted to collect digital objects such as a virtual card or computer-generated character which can be viewed on a display of the machine.

The entertainment machine may provide other functions which may be the primary function of the machine, such as a telephone function. The machine may be an enhanced version of a PDA (portable digital assistant) for example.

### BACKGROUND TO THE INVENTION

Some aspects of the invention are based on our realisation that it may be attractive to users to provide entertainment machines that are capable of swapping digital objects by means of a short-range wireless link.

### SUMMARIES OF THE INVENTION

According to one aspect of the invention a portable entertainment machine comprises a digital object store adapted to store digital objects, a short-range wireless transceiver device capable of transmitting and receiving signals that are representative of a digital object to and from the transceiver of another portable entertainment device, and a manually operable control adapted to permit the user of the entertainment machine to exercise at least some control over swapping of digital objects between the digital object stores of two or more such entertainment machines.

By ‘transceiver’ we mean a device or devices capable of transmitting and receiving, but we do not intend the term to be restricted to devices which transmit and receive alternately.

The use of a short-range wireless link, such as a Bluetooth™ network or an IrDA (Infra Red Data Association) network provides interest associated with the fact that swapping of digital objects is generally only possible when two machines are within range of each other. This provides an additional interest factor especially when the machine users are on the move, since the ability to swap will depend upon what other machines come into range of the user's machine. Also, it is generally likely to be difficult to collect a comprehensive collection of available data objects since the opportunities to swap may be limited.

The machine preferably comprises an electronic display capable of being used to display to the machine user one or more of any digital objects currently held in the digital object store of the machine.

The electronic display will usually be a visual display but it may in some cases be an audible display and it may be an audio-visual display.

When the display is a visual display the display may be arranged to display the entire contents of the digital object store, or it may be adapted to display a list of the objects held in the store and may be capable of displaying a more detailed representation of a digital object when that object is selected from the list.

The displayed object may, for example, take the form of a decorative card or token when amusement is to be derived by collecting such cards or tokens. The cards may be sport cards, such as football player cards. Such cards or tokens may have an aesthetically pleasing appearance, to increase their desirability, but in some cases, for example in science fiction war games, the displayed objects may portray a frightening element such as an evil alien.

When the display is a visual display this may be in the form of a liquid crystal display, for example.

The manually operable control could be a voice-activated control but preferably comprises a touch-sensitive device such as one or more control buttons or a touch-sensitive display.

The entertainment machine preferably comprises a casing of a size that is suitable for putting in a pocket, the casing preferably housing a battery for powering the machine, but if desired power could be supplied by a lead connected to a separate battery pack.

The data object may comprise a static image or a moving image such as a video-clip or an animation, and the image may have associated textual information which may be displayed on the display, or associated audio information which may be played by an audio playback component of the machine if the machine is so equipped.

The machine is preferably adapted to provide to the user information on data objects that become potentially available to be acquired from a similar machine that comes within range of the machine, to enable the user to take a decision on whether or not to proceed with a potential swapping transaction.

The machine may, however, be capable of being provided by the user with a standing instruction to swap a certain data object or category of data objects in the data object store for another specified data object or category of data objects if such a required object or object category becomes available for swap, and any conditions imposed on the swap by the user are complied with.

The digital object store may comprise a retained object portion for storing data objects for which the machine user has taken a decision to retain at least for the time being, or for data objects for which the user has not yet taken a decision on whether to retain or swap, and a selected article window portion of the data store in which data objects are placed for which the user has taken at least a preliminary decision to dispose of provided that an acceptable swap deal can be arranged.

The significance of the selected article window portion of the data store is that when the user's machine comes within range of another similar machine it is preferably arranged that information is transmitted to the other machine to inform the other machine of the content of the selected article window store.

Desirably both machines will comprise a selected article window store, and the contents of the selected article window stores are made available to the other machine, and the machines are adapted to display to their respective users, in a reciprocal display portion, information on the content of the selected article window store of the other machine.

Preferably, the machine is provided with an alert device for alerting the user to the availability of a potential swap, such as an audible alert device or a vibration producing device.

Of course, since the aim is to facilitate a possible swap of a data object it will not usually be desirable to transmit the full digital data object to the other machine until a swap deal has been agreed, unless some restrictive conditions are intimately associated with the initial transfer. For example the restrictive condition may be a time limit on the use of the digital object. Such an arrangement would have the advantage that the potential recipient of the data object could display the data object for a limited length of time to facilitate a decision being made as to whether or not the data object is to be acquired by proceeding with a swap transaction.

When the data object is a game program, the current owner of the game may allow the user of the other machine to sample playing of the game by exercising game control over the wireless connection, the game being run on the machine of the current game owner, or the user of the second machine may merely be permitted to watch the game being played.

The machine preferably comprises manually operable selection means to enable the user of the machine to select which data objects are transferred from the retention portion of the store to the selected article window portion of the store and vice-versa.

The machine preferably comprises a swap proposal indicator means for indicating to another, similar machine the swap transaction being proposed, and preferably this comprises a linking indicator function adapted to link the representations of the digital data objects held by the two machines in their selected article window stores, and to communicate that link indicator to the other machine.

Preferably the machine comprises a swap approval indicator means which is adapted to respond to transmit a response to the other machine in answer to the output of the linking indicator function of the machine which first suggests a swap proposal.

A swap control function is arranged to be initiated on acceptance of the proposed swap by the other machine.

Once both machines have indicated acceptance of the proposed swap a swap procedure is initiated, preferably by the machine that first proposed the possible swap.

Preferably swap control procedures are implemented to reduce or eliminate the possibility of one machine user cheating during the swapping procedure by accepting a digital object without providing a digital object in return.

For example, a swap protocol may be utilised which ensures that the data objects that have been agreed to be swapped are transmitted simultaneously by the two machines.

Alternatively, or in addition, each machine may comprise an escrow store adapted to receive a digital object and an escrow store inspection means adapted to test the authenticity of a digital object held in the escrow store.

The swap procedure preferably then comprises the initiating machine transmitting the data object to the escrow store of the other machine, and the other machine transmitting the other data object to the escrow store of the first machine.

Preferably the transmitted data objects have accompanying signed certificates which provide evidence to the recipient escrow store of the authenticity of the transmitted data objects, and on confirmation by both machines that the machines have both verified the authenticity of the data objects held in the escrow stores, an exchange of authenticity verification signals enables the data objects to be released from the escrow stores to be deposited in the respective retention stores of the machines.

The machine preferably comprises a data object input means to enable data objects to be loaded into the machine by a purchasing transaction from a data object vendor rather than by a data object swapping transaction.

The data object input means may comprise a reader adapted to read a physical storage medium such as a compact flashcard, the reader being arranged to load purchased data objects into the machine store, (and preferably the storage medium is arranged to be disabled following reading). Alternatively, or in addition, the data object input means may utilise a short-range wireless network, cellular telephony or a direct connection, such as USB. The user may then acquire data objects when the user's machine comes within range of a static supplier of data objects. Payment for such data objects can then be made by some wireless electronic payment facility.

The nature of the digital data object will now be further discussed in more detail.

The digital data object may be a game program which when run on the entertainment machine enables the user to play a game. For example, the game program may be a program to implement a single-player treasure seeking adventure game. Alternatively the game implemented may involve an additional player or players who communicate with the said entertainment machine, on which the game is run, by means of a short-range network such as a piconet, the additional players not gaining access to a copy of the game through playing the game.

Such an entertainment machine is enabled to implement different games according to the different game programs held in the store of games.

Swapping of the digital object may not necessarily involve loss of a digital object by either machine, but instead providing a copy (subject to suitable copyright permissions) of a digital object to another user in exchange for receiving a copy of a different digital object. This is a potentially desirable feature particularly when the digital object is a game program.

The digital data objects may comprise a game feature, for example a feature which potentially assists a player to play a game, or achieve a higher score, or reach a higher level of the game such as extra energy, additional player abilities to control a game element, enhancements to the powers of a game piece or character etc.

The machine may be location aware (eg GPS or from beacons on known sites, or some of the piconet members may be location aware and share their location with other piconet members). This location awareness may be a parameter to playing the game, eg you are in my team if you live in Room 101, the other team if you are in Room 102.

The portable amusement machine may be adapted to perform other functions, for example a mobile telephone, in which case the display may be the display that is used for the telephone functions, and the buttons used for telephone functions may also be used in controlling the swapping of digital objects.

The digital object may be an enhancement to the functionality of the existing machine.

When the machine has a mobile telephone function the digital object may be a ring tone.

The machine in accordance with the first aspect of the invention will generally comprise a processing unit and software adapted to cause the swapping of digital objects in response to user input commands.

According to a second aspect of the invention we provide software encoded on a data carrier which when loaded into a control processor causes the entertainment machine to operate in accordance with the first aspect of the invention.

According to a third aspect of the invention we provide apparatus to enable a plurality of players to swap digital objects, the apparatus comprising a short-range wireless network, a plurality of portable entertainment machines for carrying by respective players, each machine being in accordance with the first aspect of the invention.

The invention will now be further described, by way of example only, with reference to the accompanying drawings.

### BRIEF DESCRIPTION OF THE DRAWINGS

FIG. 1 is a schematic front elevation of a portable entertainment machine in accordance with the invention and shown in a condition just prior to a swap transaction being effected.

FIG. 2 shows the digital object store of the machine of FIG. 1,

FIG. 3 schematically shows two machines similar to that of FIG. 1 in communication with each other and in the condition just prior to executing a swap transaction,

FIG. 4 shows a modification to the machine of FIG. 1 incorporating cellular telephone functions,

FIG. 5 is a flow chart of the steps involved in setting up and completing a swap transaction, and

FIG. 6 shows a digital object vending machine.

### DESCRIPTION OF PREFERRED EMBODIMENTS

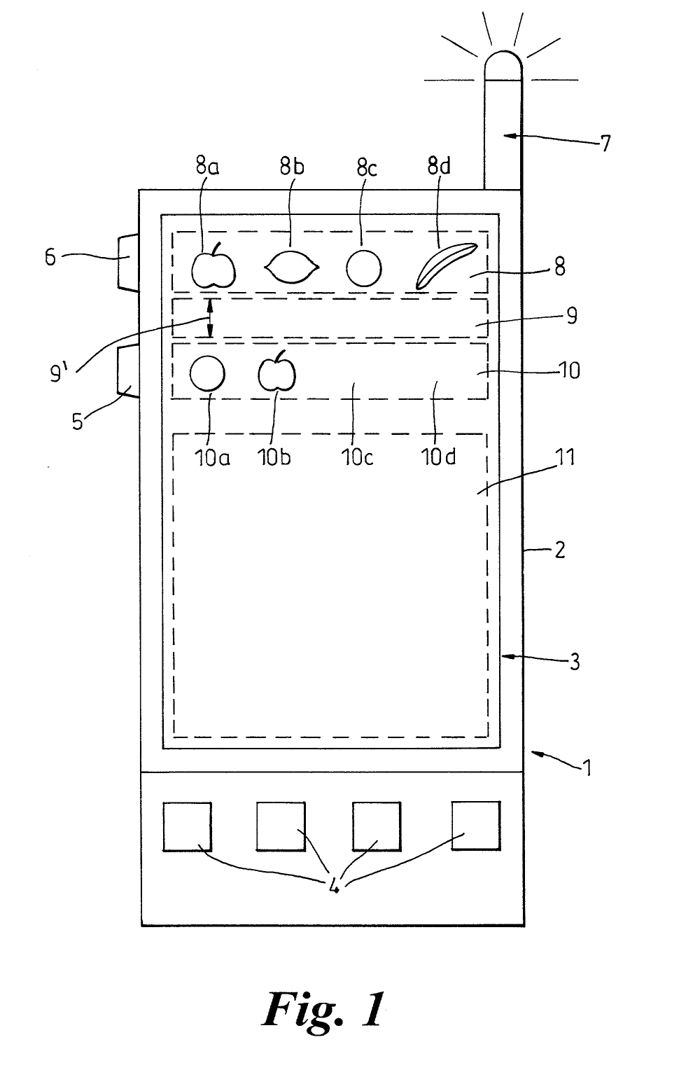

With reference to FIG. 1, the entertainment machine 1 typically comprises a housing 2 of a size to fit in a pocket (but could be larger if desired), a liquid crystal display 3, CPU, ROM and RAM contained within the housing 2, various control buttons 4, 5, 6 and a wireless transceiver 7 such as an IrDA transceiver.

In one mode of operation of the display 3, selected by operation of one of the buttons 4, and as shown in FIG. 1, the display comprises a user selected article window portion 8, a proposed-swap indicator portion 9, a reciprocal display portion 10 displaying objects offered by another machine for swapping, and a main game display portion 11.

The selected article window 8 displays images corresponding to data objects that the machine user has selected from his/her store of data objects to be the subject of a possible swap transaction.

For the purposes of illustration only, the digital object images shown in FIG. 1 in the selected article window 8 and in the offered objects window 10 are shown as fruit images, but it will be appreciated that the images can be of any form and could be much more elaborate in design, for example a sci-fi character.

By operation of one of the control buttons 4 an enlarged image of a data object selected from selected article window 8 can be displayed on the main game display portion 11 for full appreciation by the user.

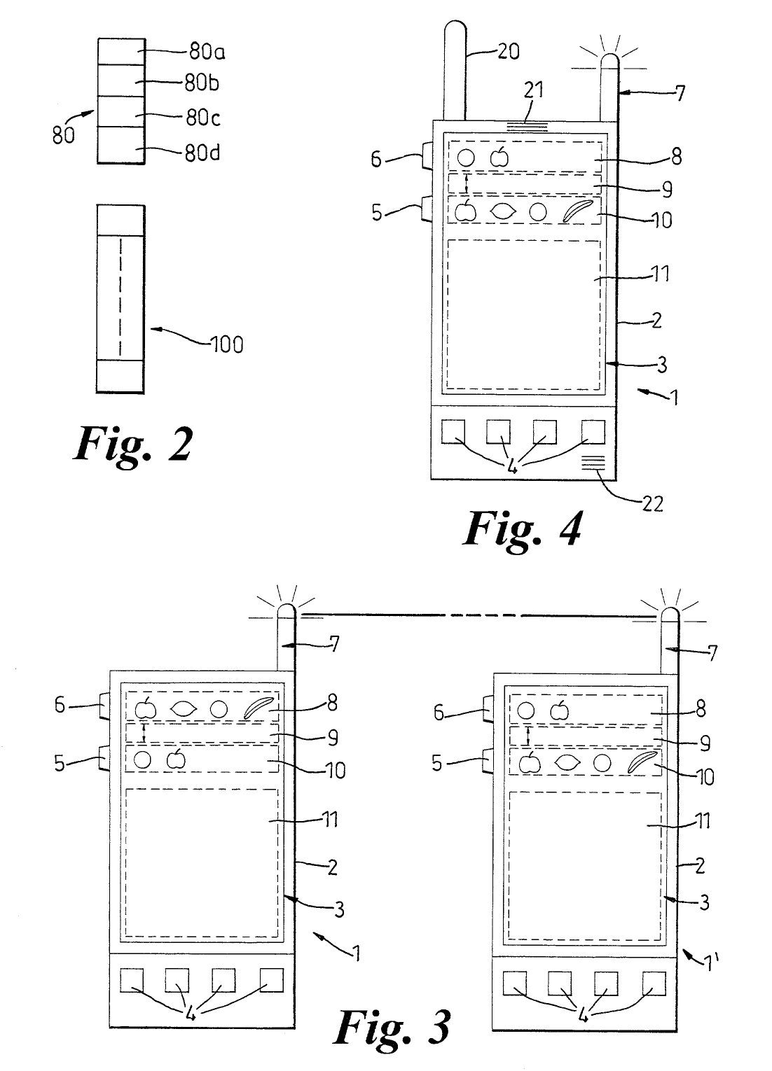

FIG. 2 indicates the organisation of the RAM storage, constituting a digital object store, for the digital data objects. The digital data store comprises a retained object store 100 and a selected article window store 80, comprising storage locations 80a, 80b, 80c, 80d corresponding to the four elements 8a to 8d of the selected article window display for four digital objects which have been transferred from the retained object store 100 under control of buttons 4.

The user can inspect the content of the retained object store 100 by requesting, with suitable use of control buttons 4, the display of a list of retained objects in the main display portion 11. Selected objects can be transferred from the retained object store 100 to selected article window storage 80 which can hold four digital objects in locations 80a to 80d. Images or icons representative of the digital objects corresponding to the data objects in the locations 80a to 80d are displayed in the selected article window display, but not necessarily in corresponding positions, as will be explained. When only an icon is displayed in selected article window display 8 a fuller image of the data object may be chosen to be shown in main display 11.

Button 6 enables the images or icons displayed in the selected article window display to be scrolled, that is such that the image displayed at 8a moves to 8b, that at 8b to 8c, that at 8c to 8d, and that at 8d moves to 8a. The purpose of scrolling the display 8 is to enable a proposed swap transaction to be set up on the displays 8, 9, 10, the proposed swap being indicated by a linking indicator function in the form of a linking arrow 9′ of display portion 9, which links the image in position 8a with the image in position 10a of reciprocal display 10.

Button 5 similarly enables the display 10 to be scrolled to bring whichever image or icon the user desires to align with the linking arrow 9′. It will therefore be appreciated that by use of buttons 5, 6 the user can set up a proposed swap based on a selection of any one of the objects/icons in display 8 with a selection of any one of the objects/icons in display 10.

FIG. 3 shows two machines, 1, 1′ which are in communication with each other by way of transceivers 7. It will be seen that the selected article window display 8 of machine 1 has been transmitted to machine 1′ to appear in the reciprocal display 10 of machine 1′. And the selected article window display 8 of machine 1′ has been transmitted to machine 1 to appear in the reciprocal display 10 of machine 1.

When the user of machine 1 is happy with the proposed swap indicated by the linking arrow of display 9 of machine 1, the user transmits to machine 1′ an approval signal, by suitable operation of a button 4 of machine 1, and the user of machine 1′ can then signify his or her approval of the swap.

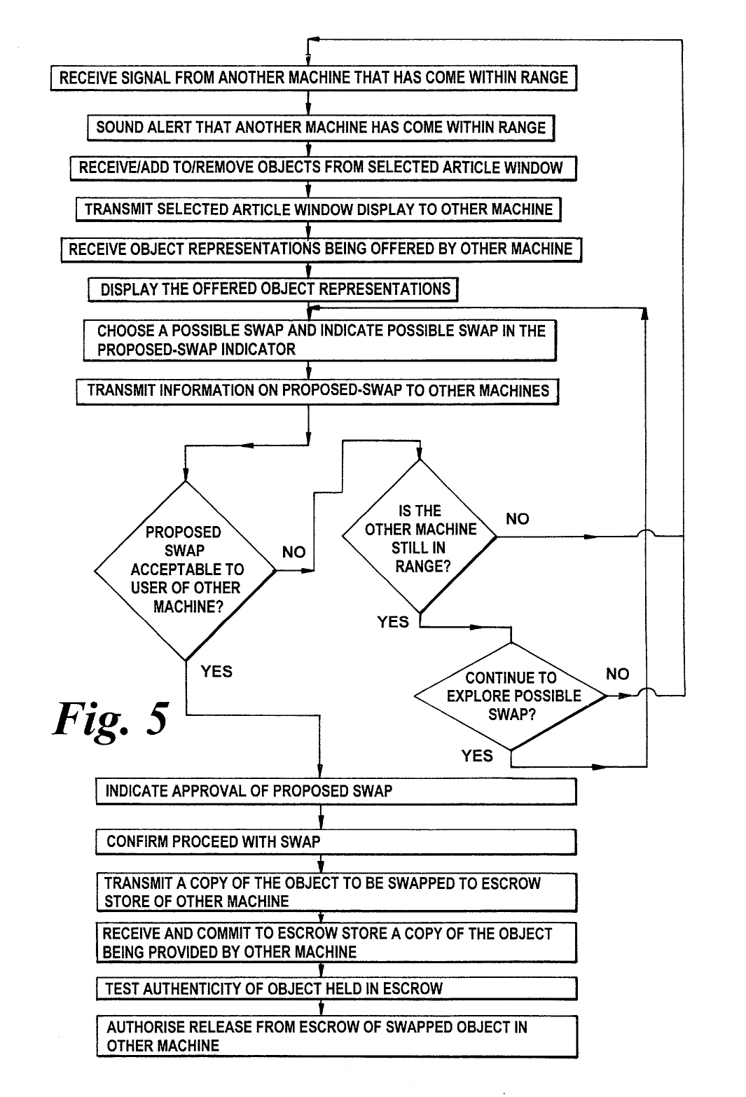

The overall procedure for the communications is set out in FIG. 5.

FIG. 4 shows a multi-purpose embodiment of the invention which is usable both as a cellular telephone and as an entertainment machine. The machine of FIG. 5 comprises a cellular telephone transceiver 20, speaker 21 and microphone 22. When telephone mode is selected by operation of control buttons 4, the main display 11 is used to show telephone features such as address book numbers, whereas when a game mode is selected by operation of buttons 4 the display 11 is used to display a game such as a treasure-seeking adventure game. It should be noted that for such embodiments of the invention, the device may be a conventional computing device with cellular telephone capability installed with appropriate software.

Speaker 21 may be used to provide an audio element associated with a selected digital object when that object has been selected for display in display 11.

The machine 1, 1′ can only exchange digital objects when the respective transceivers 7 are within range of each other.

In a further modification to the machine of FIG. 1 the buttons 4 can be operated to set up a standing instruction for exchange of digital objects. On activation a filter is implemented for filtering digital objects that can be allowed to be displayed in display 10 as the filter operates in conjunction with an automatic exchange function which operates as follows. The user of machine 1 selects from the retained object store 100 data objects which he or she is prepared to exchange, and places those objects in store 80, (and those objects are consequently displayed in display 8 of machine 1). The filter is set and icons of the objects that the user of machine 1 is prepared to accept in exchange for any other items displayed in display 8 are then displayed in display 10. In the event that the machine 1 comes into range of another machine that is offering to swap any of the data objects that have been displayed in 10 in order to set the filter, then machine 1 automatically transmits to the other machine 1′ the contents of selected article window display 8 of that machine, and a swapping transaction can then proceed, assuming of course that the user of machine 1′ is happy to accept the transaction that has been proposed by machine 1. Of course, if machine 1′ has also been set to automatic exchange mode, then a swap transaction will be effected, providing that the swap criteria set on the two machines are compatible.

In a further modification to the machine of FIG. 1 the software is configured to allow multi-player games being played on machine 1 to be controlled by remote players, each of which has a similar machine to machine 1, and communicates with machine 1 by way of a short-range piconet.

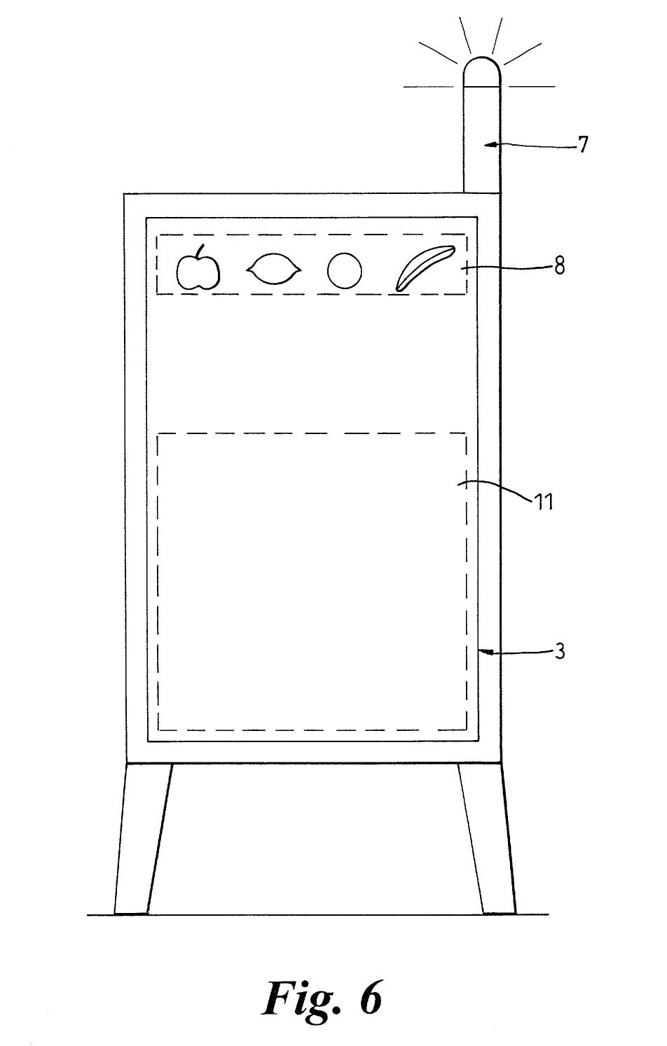

FIG. 6 schematically shows a digital object vending machine which will desirably be mounted in a fixed location, but could be mounted in a public transport vehicle. Parts of the vending machine which correspond to the parts of the machine of FIG. 1 have been given corresponding reference numerals.

The vending machine will allow a machine user who comes within range to purchase digital objects, for example by a charge made to their cellular telephone account, the vending machine owner being reimbursed by the cellular telephone service provider (who may retain a commission).

Preferably exchange of digital objects is carried out in such a way that the creation of digital objects does not lose economic benefit by cost-free copying by others. Mechanisms can be applied to prevent this, or to minimise the risk. One approach to minimising risk could be to require any “transaction” to include the identity of the provider (which could thus be embedded in the digital object—an embedded audit trail). If users also had to register with a central service, this approach could render illicit copying detectable. An even more complete (if practically more complex) solution would be to register each transaction with a central service. Further minimisation as prevention of risk could be achieved by locating the digital object exchange application, and possibly the digital objects themselves, within a tamper proof device within the machine logically and physically isolated from tampering—preferably one with a cryptographic identity. Such a device is discussed in WO 00/48063 (Hewlett-Packard). Transfer of digital objects could thus be constrained to be carried out in a cryptographic exchange under a shared session being in conventional manner. Other known approaches to requiring validation for use of software (dongles, smartcards etc) can also be employed.

1. A portable entertainment machine comprising a digital object store adapted to store digital objects, having a short-range wireless transceiver device capable of transmitting and receiving signals that are representative of a digital object to and from the transceiver of another portable entertainment device, and a manually operable control adapted to permit the user of the entertainment machine to exercise at least some control over swapping of digital objects between the digital object stores of two or more such entertainment machines.

2. A machine as claimed in claim 1 comprising an electronic display capable of being used to display to the machine user one or more of any digital objects currently held in the digital object store of the machine.

3. A machine as claimed in claim 2 in which the electronic display comprises a visual display.

4. A machine as claimed in claim 2 in which the electronic display comprises an audible display.

5. A machine as claimed in claim 4 in which the display is adapted to display the entire contents of the digital object store.

6. A machine as claimed in claim 4 in which the display is adapted to display a list of the objects held in the store and is capable of displaying a more detailed representation of a digital object when that object is selected from the list.

7. A machine as claimed in claim 1 in which the manually operable control is a voice-activated control.

8. A machine as claimed in claim 1 in which the manually operable control comprises a touch-sensitive device.

9. A machine as claimed in claim 1 comprising a casing of a size that is suitable for putting in a pocket.

10. A machine as claimed in claim 1 adapted to provide to the user information on data objects that become potentially available to be acquired from a similar machine that comes within range of the machine, to enable the user to take a decision on whether or not to proceed with a potential swapping transaction.

11. A machine as claimed in claim 1 in which the machine is capable of being provided by the user with a standing instruction to swap a certain data object or category of data objects in the data object store for another specified data object or category of data objects if such a required object or object category becomes available for swap, and any conditions imposed on the swap by the user are complied with.

12. A machine as claimed in claim 1 in which the digital object store comprises a retained object portion for storing data objects for which the machine user has taken a decision to retain at least for the time being, or for data objects for which the user has not yet taken a decision on whether to retain or swap, and a selected article window portion of the data store in which data objects are placed for which the user has taken at least a preliminary decision to dispose of provided that an acceptable swap deal can be arranged.

13. A machine as claimed in claim 12 characterised in that when the user's machine comes within range of another similar machine information is transmitted to the other machine to inform the other machine of the content of the selected article window store.

14. A machine as claimed in claim 13 in which the display comprises a reciprocal display portion adapted to display the content of the selected article window store of another machine which comes within range.

15. A machine as claimed in claim 1 in which the machine is provided with an alert device for alerting the user to the availability of a potential swap.

16. A machine as claimed in claim 1 which is adapted to transmit an incomplete digital object for sampling by the user of another machine.

17. A machine as claimed in claim 1 which is adapted to transmit a data object for sampling over a limited length of time to facilitate a decision being made as to whether or not the data object is to be acquired by proceeding with a swap transaction.

18. A machine as claimed in claim 1 in which the data object is a game program, and the machine is so arranged that the current owner of the game can allow the user of another similar machine within range to sample playing of the game by exercising game control over the wireless connection, the game being run on the machine of the current game owner.

19. A machine as claimed in claim 12 comprising manually operable selection means to enable the user of the machine to select which data objects are transferred from the retention portion of the store to the selected article window portion of the store and vice-versa.

20. A machine as claimed in claim 1 in which the machine comprises a swap proposal indicator means for indicating to another, similar machine the swap transaction being proposed.

21. A machine as claimed in claim 20 in which the swap proposal indicator means comprises a linking indicator function adapted to link the representations of the digital data objects held by the two machines in their selected article window stores, and to communicate that link indicator to the other machine.

22. A machine as claimed in claim 21 comprising a swap approval indicator means which is adapted to respond to transmit a response to the other machine in answer to the output of the linking indicator function of the machine which first suggests a swap proposal.

23. A machine as claimed in claim 1 comprising swap control function arranged to be initiated on acceptance of a proposed swap by a similar such machine.

24. A machine as claimed in claim 23 in which a swap protocol is utilised which ensures that the data objects that have been agreed to be swapped are transmitted simultaneously by the two machines.

25. A machine as claimed in claim 1 comprising a data object input means to enable data objects to be loaded into the machine by a purchasing transaction from a data object vendor rather than by a data object swapping transaction.

26. A machine as claimed in claim 25 in which the data object input means comprises a reader adapted to read a physical storage medium, the reader being arranged to load purchased data objects into the machine store.

27. A machine as claimed in claim 26 in which the reader is arranged to disable the storage medium following reading.

28. A machine as claimed in claim 25 in which the data object input means utilises a short-range wireless network.

29. A machine as claimed in claim 25 in which the data input means utilises cellular telephony.

30. A machine as claimed in claim 1 in which the digital data object is a game program which when run on the entertainment machine enables the user to play a game.

31. A machine as claimed in claim 30 in which the game implemented by the digital data object involves an additional player or players who communicate with the said entertainment machine, on which the game is run, by means of a short-range wireless network, the additional player/s not gaining access to a copy of the game through playing the game.

32. A machine as claimed in claim 30 in which the digital data object comprises a game feature for assisting a player to play a game.

33. A machine as claimed in claim 3 adapted to be operable as a mobile telephone, said display being used to display the telephone functions.

34. A machine as claimed in claim 1 in which the digital object is an enhancement to the functionality of the existing machine.

35. A machine as claimed in claim 33 in the digital object is a ring tone.

36. Software encoded on a data carrier which when loaded into a control processor of a portable entertainment machine causes the machine to operate as claimed in claim 1.

37. Apparatus to enable a plurality of players to swap digital objects, the apparatus comprising a short-range wireless network, a plurality of portable entertainment machines for carrying by respective players, each machine being as claimed in claim 1.

38. A machine as claimed in claim 3 in which the displayed object takes the form of a decorative virtual card or token.

39. A machine as claimed in claim 3 in which the data object comprises a moving image.

40. A machine as claimed in claim 39 in which the image has associated textual information which is displayed on the display.

41. A machine as claimed in claim 39 in which the image has associated audio information which is suitable for being played by an audio playback component of the machine.

42. A computer program product comprising a computer usable medium having computer readable program code embodied therein executable by a portable entertainment machine which comprises a short-range wireless transceiver device capable of transmitting and receiving signals to and from the transceiver of another portable entertainment device, and a manually operable control adapted to permit the user of the entertainment machine to exercise at least some control over the use of the transceiver device: the computer program product comprising code that when loaded into the portable entertainment machine causes the portable entertainment machine to be capable of swapping, by way of the transceiver device, signals that are representative of digital objects for swapping digital objects between digital object stores of two or more such entertainment machines.

43. A computer program product as claimed in claim 42 comprising code means which causes the machine to be capable of displaying a list of the objects held in the store, and to be capable of displaying a more detailed representation of a digital object when that object is selected by a user from the list.

44. A computer program product as claimed in claim 42 comprising code means which causes the machine to be adapted to provide to the user information on data objects that become potentially available to be acquired from a similar machine that comes within range of the machine, to enable the user to take a decision on whether or not to proceed with a potential swapping transaction.

45. A computer program product as claimed in claim 42 comprising code means which causes the machine to be capable of being provided by the user with a standing instruction to swap a certain data object or category of data objects in the data object store for another specified data object or category of data objects if such a required object or object category becomes available for swap, and any conditions imposed on the swap by the user are complied with.

46. A computer program product as claimed in claim 42 comprising code means which causes the machine to allocate a retained object portion of the digital object store for storing data objects for which the machine user has taken a decision to retain at least for the time being, or for data objects for which the user has not yet taken a decision on whether to retain or swap, and to allocate a selected article window portion of the data store in which data objects can be placed for which the user has taken at least a preliminary decision to dispose of provided that an acceptable swap deal can be arranged.

47. A computer program product as claimed in claim 46 characterised in that the product comprises means which causes the machine to operate such that when the user's machine comes within range of another similar machine information is transmitted to the other machine to inform the other machine of the content of the selected article window store.

48. A computer program product as claimed in claim 47 in which the product comprises code means which causes a display of the machine to comprise a reciprocal display portion adapted to display the content of the selected article window store of another machine which comes within range.

49. A computer program product as claimed in claim 42 comprising code means which causes the machine to issue an alert to the user upon the availability of a potential swap.

50. A computer program product as claimed in claim 42 comprising code means which causes the machine to be capable of transmitting an incomplete digital object for sampling by the user of another machine.

51. A computer program product as claimed in claim 42 comprising code means which causes the machine to transmit a data object for sampling over a limited length of time to facilitate a decision being made as to whether or not the data object is to be acquired by proceeding with a swap transaction.

52. A computer program product as claimed in claim 42 in which the data object is a game program, the program comprising code means which configures the machine whereby the current owner of the game can allow the user of another similar machine within range to sample playing of the game by exercising game control over the wireless connection, the game being run on the machine of the current game owner.

53. A computer program product as claimed in claim 42 comprising code means which configures the manually operable control to enable the user of the machine to select which data objects are transferred from the retention portion of the store to the selected article window portion of the store and vice-versa.

54. A computer program product as claimed in claim 42 comprising code means which configures the machine to provide a swap proposal indicator means for indicating to another, similar machine the swap transaction being proposed.

55. A computer program product as claimed in claim 54 in which the swap proposal indicator means comprising a linking indicator function adapted to link the representations of the digital data objects held by the two machines in their selected article window stores, and to communicate that link indicator to the other machine.

56. A computer program product as claimed in claim 55 comprising code means which configures the machine to provide a swap approval indicator means which is arranged to respond to transmit a response to the other machine in answer to the output of the linking indicator function of the machine which first suggests a swap proposal.

57. A computer program product as claimed in claim 42 comprising code means which configures the machine to provide a swap control function arranged to be initiated on acceptance of a proposed swap by a similar such machine.

58. A computer program product as claimed in claim 57 comprising code means which provides a swap protocol that ensures that the data objects that have been agreed to be swapped are transmitted simultaneously by the two machines.

59. A computer program product as claimed in claim 42 comprising code means which configures the machine for enabling data objects to be loaded into the machine by purchasing transaction from a data object vendor rather than by a data object swapping transaction.
